(19) United States
(12) Patent Application Publication
(10) Pub. No.: US 2024/0121621 A1
(43) Pub. Date: Apr. 11, 2024

(54) OUT OF DISTRIBUTION SAMPLES REPORTING FOR NEURAL NETWORK OPTIMIZATION

(71) Applicant: QUALCOMM Incorporated, San Diego, CA (US)

(72) Inventors: Yuwei REN, Beijing (CN); Chenxi HAO, Beijing (CN); Yu ZHANG, San Diego, CA (US); Ruiming ZHENG, Beijing (CN); Liangming WU, Beijing (CN); Qiaoyu LI, Beijing (CN); Rui HU, Beijing (CN); Hao XU, Beijing (CN); Yin HUANG, Beijing (CN)

(21) Appl. No.: 18/276,438

(22) PCT Filed: Apr. 21, 2021
(86) PCT No.: PCT/CN2021/088657

§ 371 Date: Aug. 8, 2023

(51) Int. Cl. H04W 16/22; H04W 24/10

(52) U.S. Cl. CPC H04W 16/22; H04W 24/10

(57) ABSTRACT

A configuration for reporting OOD samples for neural network optimization. The apparatus receives, from a base station, a configuration to report an OOD dataset for a machine learning model. The apparatus detects an occurrence of one or more OOD events. The apparatus reports the OOD dataset comprising the one or more OOD events based on the configuration to report OOD dataset. The apparatus receives, from the base station, an update to the machine learning model. The OOD dataset may comprise raw data related to the one or more OOD events, or may comprise extracted latent data corresponding to features of raw data related to the one or more OOD events.

### BACKGROUND

### Technical Field

The present disclosure relates generally to communication systems, and more particularly, to a configuration for reporting out of distribution (OOD) samples for neural network optimization.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor, a transceiver, and/or a modem at a UE or the UE itself. The apparatus receives, from a base station, a configuration to report an out of distribution (OOD) dataset for a machine learning model. The apparatus detects an occurrence of one or more OOD events. The apparatus reports the OOD dataset comprising the one or more OOD events based on the configuration to report OOD dataset. The apparatus receives, from the base station, an update to the machine learning model.

In an aspect of the disclosure, a method, a computer-readable medium, and an apparatus are provided. The apparatus may be a device at a base station. The device may be a processor, a transceiver, and/or a modem at a base station or the base station itself. The apparatus transmits, to a user equipment (UE), a configuration to report an out of distribution (OOD) dataset for a machine learning model. The apparatus receives, from the UE, the OOD dataset comprising one or more OOD events based on the configuration to report OOD dataset. The apparatus updates the machine learning model based on the OOD dataset. The apparatus transmits, to the UE, an update to the machine learning model.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of neural networks in a wireless communication system.

FIG. 5A is a diagram illustrating an example of a machine learning model preparation.

FIG. 5B is a diagram illustrating an example of a machine learning model deployment.

FIG. 6 is a diagram illustrating an example of machine learning model optimization.

FIG. 7 is a call flow diagram of signaling between a UE and a base station.

FIG. 8A is a diagram illustrating an example of content of OOD dataset.

FIG. 8B is a diagram illustrating an example of content of OOD dataset.

FIG. 9 is a diagram illustrating an example of a patterned configuration for the OOD dataset.

FIG. 10 is a diagram illustrating an example of reporting the OOD dataset.

FIG. 11 is a flowchart of a method of wireless communication.

FIG. 12 is a flowchart of a method of wireless communication.

FIG. 13 is a diagram illustrating an example of a hardware implementation for an example apparatus.

FIG. 14 is a flowchart of a method of wireless communication.

FIG. 15 is a flowchart of a method of wireless communication.

FIG. 16 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

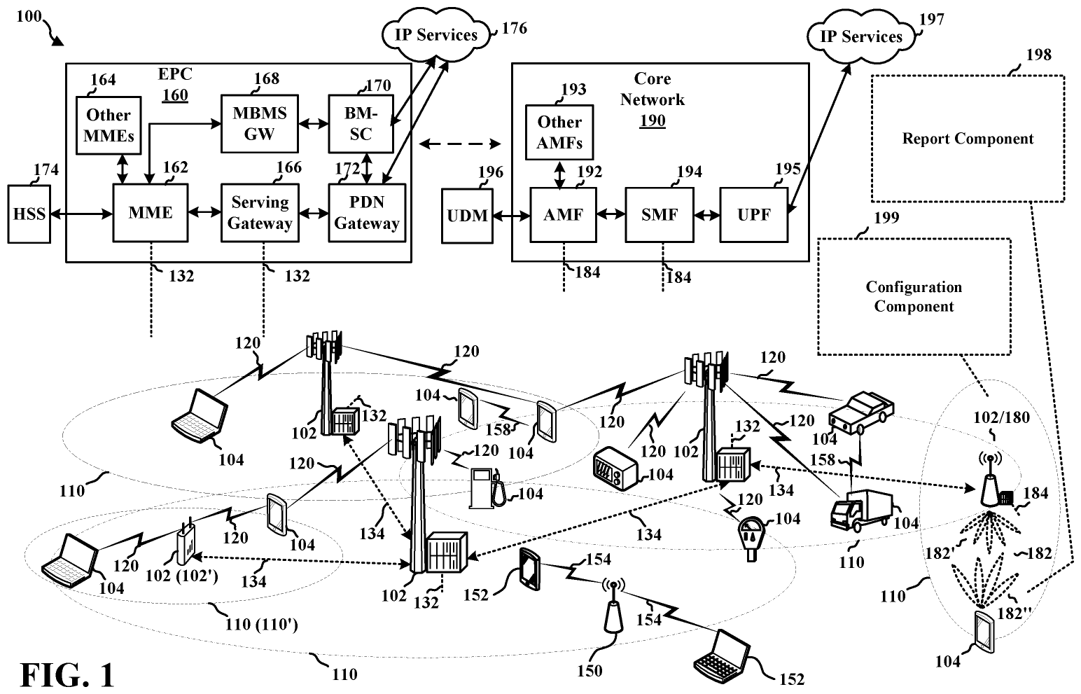

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies.

Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to report OOD occurrences for optimization of neural networks. For example, UE 104 may comprise a report component 198 configured to report OOD occurrences for optimization of neural networks. The UE 104 may receive, from a base station 180, a configuration to report the OOD dataset for a machine learning model. The UE 104 may detect an occurrence for one or more OOD events. The UE 104 may report the OOD dataset comprising the one or more OOD events based on the configuration to report the OOD dataset. The UE 104 may receive, from the base station 180, an update to the machine learning model.

Referring again to FIG. 1, in certain aspects, the base station 180 may be configured to configure a UE to report OOD occurrences for optimization of neural networks. For example, the UE 180 may comprise a configuration component 199 configured to configure a UE to report OOD occurrences for optimization of neural networks. The base station 180 may transmit, to the UE 104, a configuration to report an OOD dataset for a machine learning model. The base station 180 may receive, from the UE 104, the OOD dataset comprising one or more OOD events based on the configuration to report OOD dataset. The base station 180 may update the machine learning model based on the OOD dataset. The base station 180 may transmit, to the UE 104, an update to the machine learning model.

Although the following description may be focused on 5G NR, the concepts described herein may be applicable to other similar areas, such as LTE, LTE-A, CDMA, GSM, and other wireless technologies.

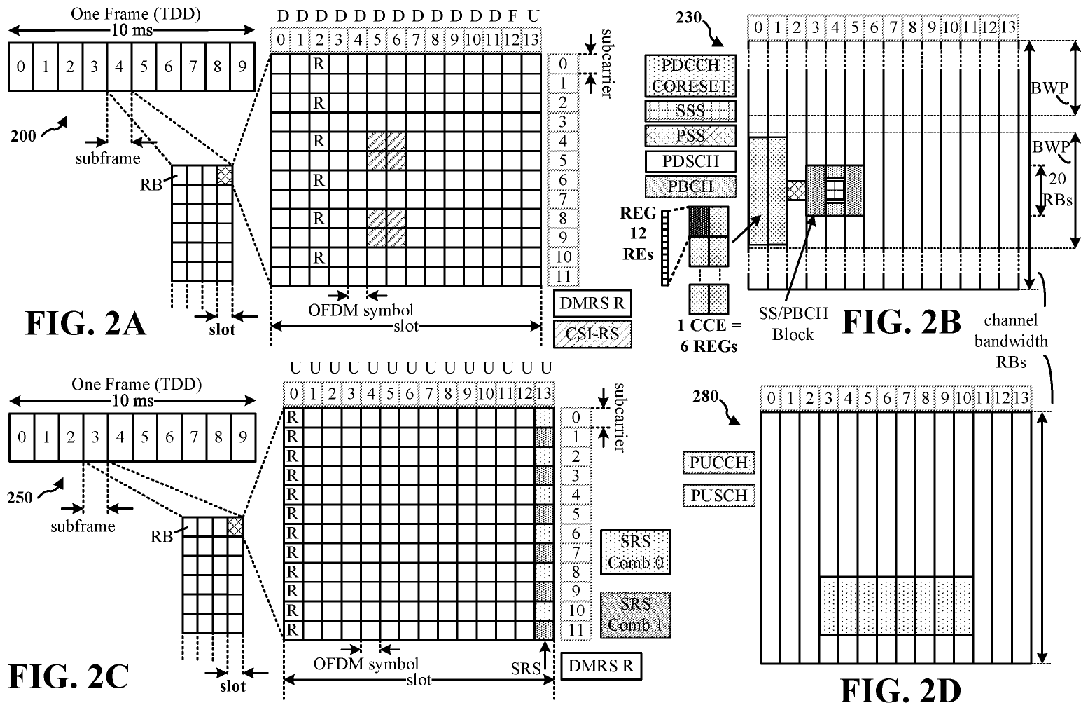

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

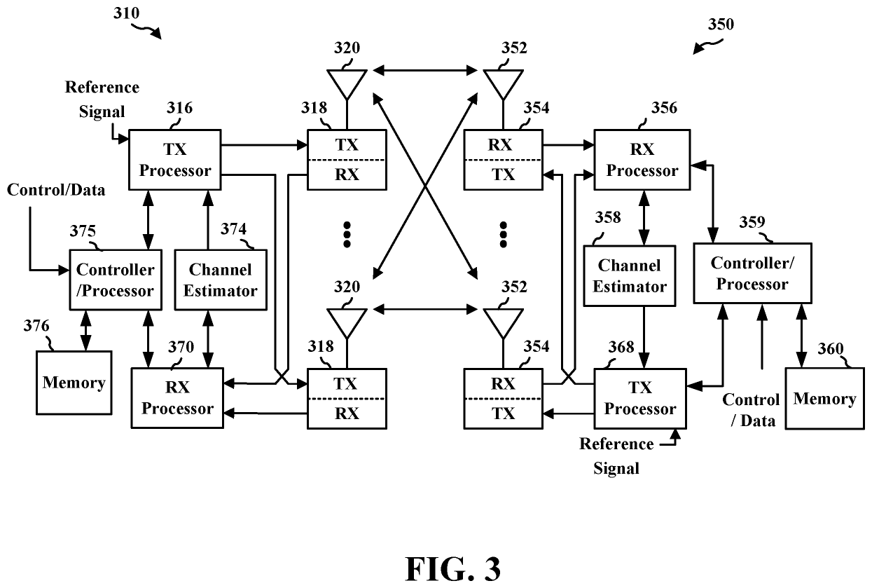

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

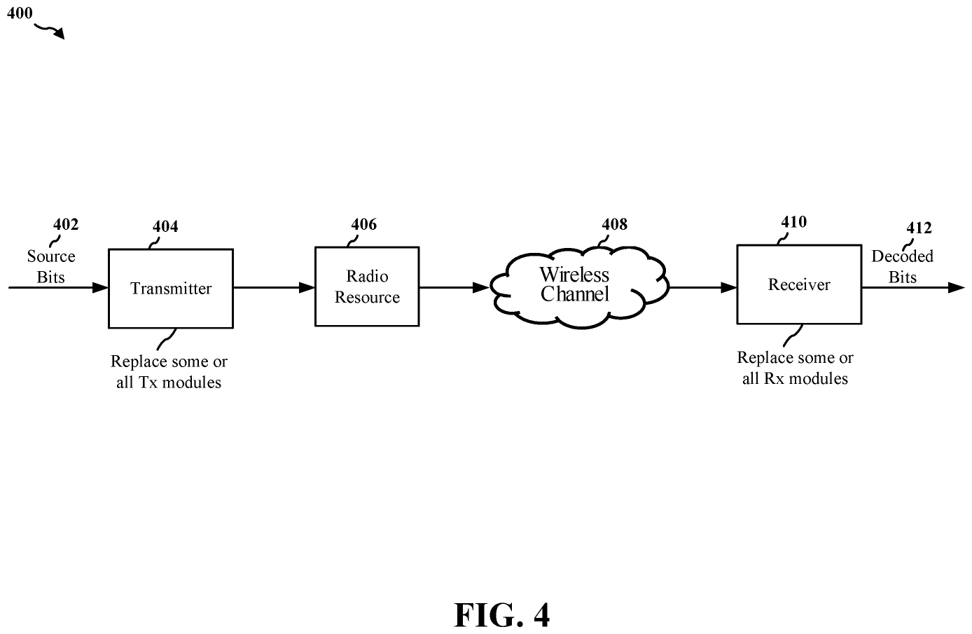

In wireless communication systems, machine learning, especially deep neural networks, has become a popular tool in wireless communications. Neural networks may be utilized in transmitters and/or receivers. For example, with reference to diagram 400 of FIG. 4, a wireless communication system may include source bits 402 and input to a transmitter 404, a radio resource 406, wireless channels 408, and a receiver 410 that outputs decoded bits 412. In some instances, neural networks in transmitter 404 may be utilized to replace some or all of the transmitter modules, such as but not limited to encoding, modulation, or precoding. In some instances, neural networks in receiver 410 may be utilized to replace some or all of the receiver modules, such as but not limited to synchronization, CHEST, detection, demodulation, or decoding.

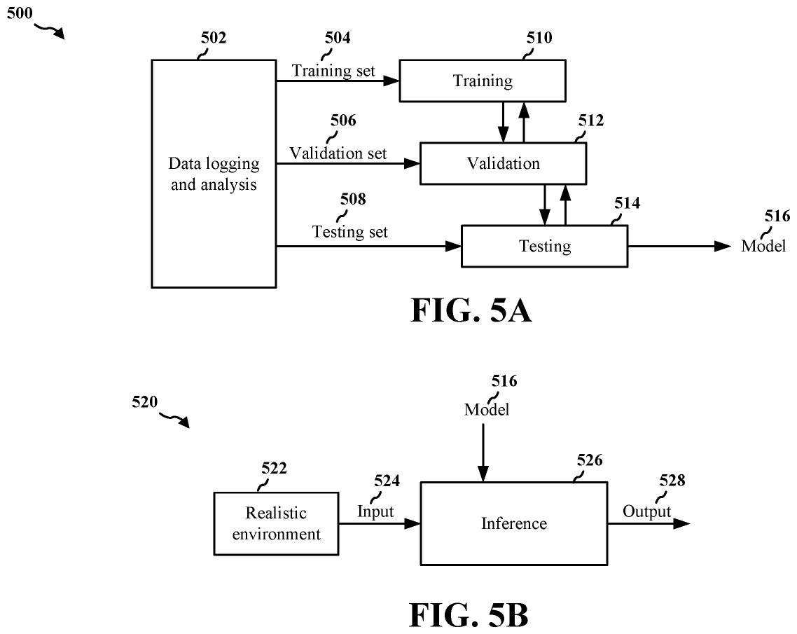

Artificial intelligence solutions may be data driven based, and the application procedure may occur in a two-stage process, model preparation and model deployment. The machine learning model preparation stage may be based on a given dataset, training of the model, validation of the model, and testing of the model. For example, diagram 500 of FIG. 5A provides an example of the machine learning model preparation stage. Data logging and analysis module 502 may provide a training set 504 to a training module 510 to train the model. The data logging and analysis module 502 may provide a validation set 506 to a validation module 512 to validate or estimate the performance of the model. The validation or estimation of performance of the model may be based a training dataset generated by the training module 510, which is provided to the validation module 512 by the training module 510. The data logging and analysis module 502 may provide a testing set 508 to the testing module 514. The testing module 514 may evaluate final model 516 performance. The testing module 514 may evaluate the final model 516 performance based in part on data from the validation module 512.

FIG. 5B provides a diagram 520 of the machine learning model deployment stage. Once the final model 516 has been determined, the model 516 may be provided to an inference module 526 in order to run live data points into the model 516. For example, input 524 from the realistic environment 522 may be inputted into the inference module 526 to run live data into the model 516, in order to produce an output 528. The output 528 may provide an output score of the performance of the model 516. The output 528 may provide an indication as to performance of the model 516 against realistic data to determine whether the model 516 may produce an output 528 within expected range or within an in-distribution (ID) space. The realistic data may be unpredictable. The realistic deployment environments may be more complicated than the expected dataset. The pre-logged dataset may not cover all of the potential scenarios which may occur in realist data.

In the model deployment, there may be instances where one or more samples from a new environment which may include different features than that of the dataset used in the machine learning preparation stage. In such instances, the one or more samples from the new environment may be out of the distribution (OOD), in comparison to the previous logged dataset within the ID. The model, when experiencing the OOD, may fail. The model encountering the one or more samples from the new environment may be an OOD event. OOD events may be unavoidable, unknown and unpredictable, or may not be easily detectible until the failure of the model.

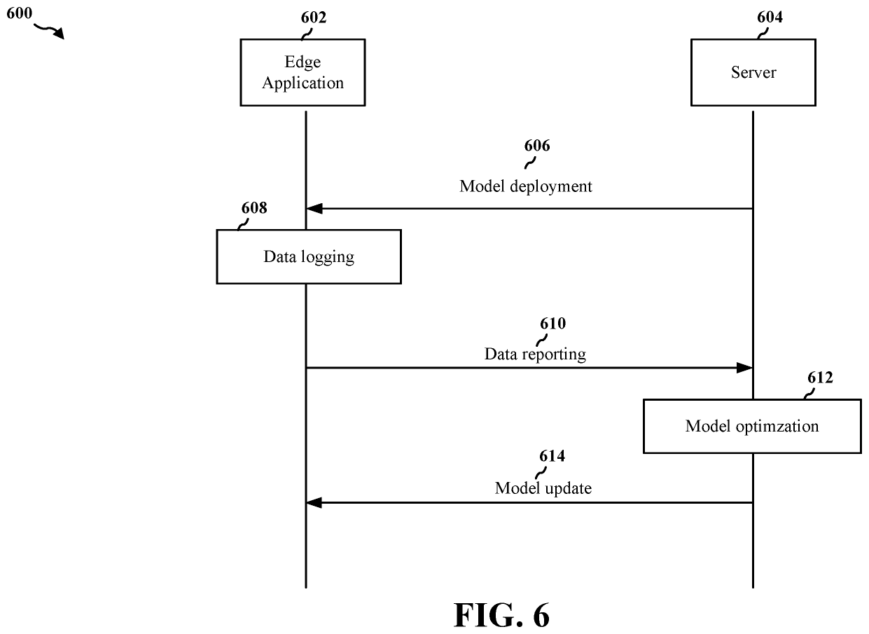

In order to maintain a robust model for all of the potential scenarios, the model may be continuously optimized. For example, diagram 600 of FIG. 6 provides an example of a continuously optimized model. The optimization process may occur between a server 604 (e.g., via a base station) and an edge application 602 (e.g., via a UE). The server 604, at 606, may deploy the model and transmit the model to the edge application 602. The edge application 602, at 608, may record the unexpected samples, which may lead to model failure or to reduced model performance. The edge application 602, at 610, may report the unexpected samples to the server 604. The server 604, at 612, may optimize the model based on the report of the unexpected samples. The server 604 may fine-tune the model based on the new logged dataset (e.g., OOD dataset) of unexpected samples (e.g., OOD events). The server 604, at 614, may release the new optimized model and transmit the updated model to the edge application 602. This optimization may be a continuous procedure and may be based on a predefined pattern. The edge application 602 may continuously monitor for OOD events, and may report the OOD events periodically. The server 604 may periodically release additional updates for the model.

However, a clear procedure for reporting of the OOD events is needed. For example, the input sample of the OOD events may be a large size, which may occupy considerable amount of resources for the reporting of the OOD events. The reporting of the OOD events may be an ad hoc part for the model optimization, but this may provide challenges for low-tier UEs related to memory of power consumption.

Aspects presented herein provide a configuration for reporting OOD samples for neural network optimization. For example, a base station may provide a UE with a configuration for reporting an OOD dataset. The configuration for reporting the OOD dataset may include the configuration for the content of the OOD samples. The configuration may include a pattern configuration for reporting the OOD dataset. The configuration may include information related to the signaling for a model optimization and/or a model update.

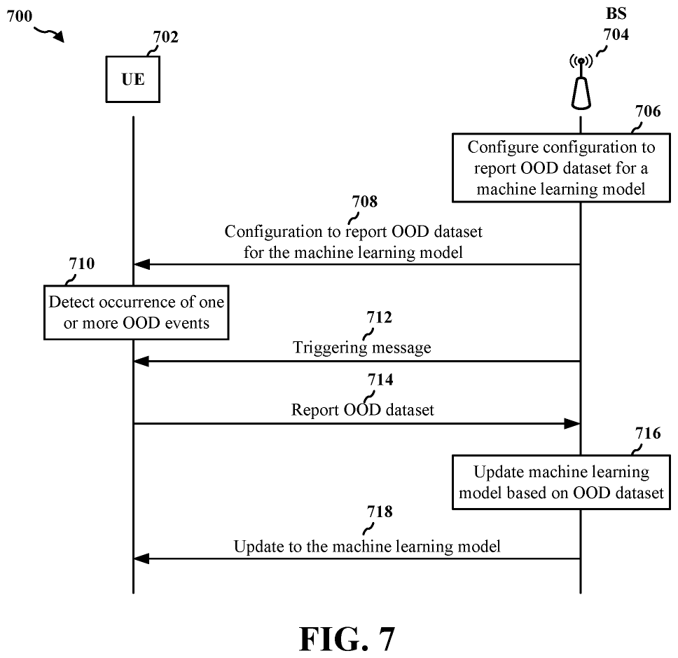

FIG. 7 is a call flow diagram 700 of signaling between a UE 702 and a base station 704. The base station 704 may be configured to provide at least one cell. The UE 702 may be configured to communicate with the base station 704. For example, in the context of FIG. 1, the base station 704 may correspond to base station 102/180 and, accordingly, the cell may include a geographic coverage area 110 in which communication coverage is provided and/or small cell 102′ having a coverage area 110′. Further, a UE 702 may correspond to at least UE 104. In another example, in the context of FIG. 3, the base station 704 may correspond to base station 310 and the UE 702 may correspond to UE 350. Optional aspects are illustrated with a dashed line.

As illustrated at 706, the base station 704 may configure a configuration to report an OOD dataset. The base station may configure the configuration to report the OOD dataset for a machine learning model.

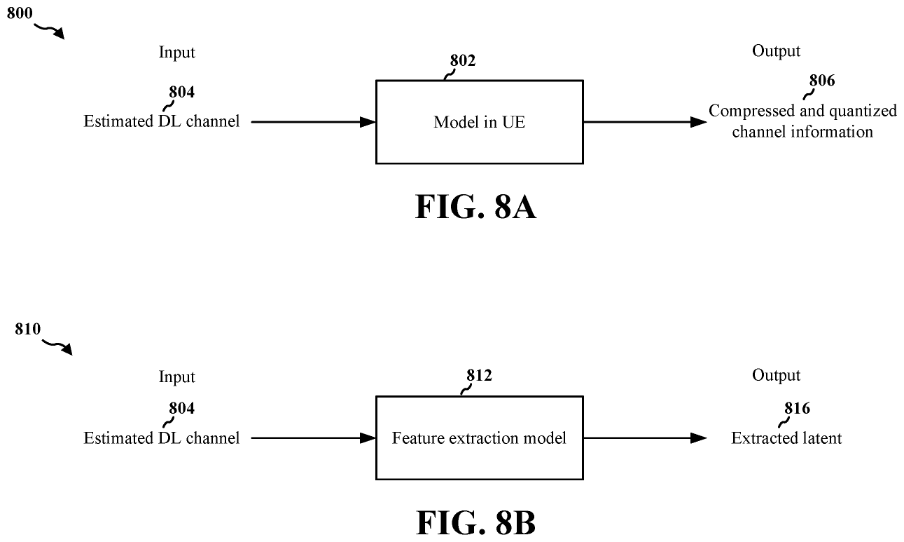

As illustrated at 708, the base station 704 may transmit the configuration to report the OOD dataset. The base station may transmit the configuration to report the OOD dataset for a machine learning model. The base station may transmit the configuration to report the OOD dataset to a UE 702. The UE 702 may receive the configuration to report the OOD dataset from the base station 704. In some aspects, the configuration to report the OOD dataset may include a content configuration for a type of content to be included in the OOD dataset. In some aspects, the content of the OOD dataset may comprise raw data which may be the input of the machine learning model. For example, with reference to the diagram 800 of FIG. 8A, in instances where the estimated downlink channel 804 is the input for the model 802 in the UE, the model 802 may output the compressed and quantized channel information 806 (e.g., one quantized channel set index). The compressed and quantized channel information 806 may be utilized as feedback to the network. The input of the model 802 may be the estimated downlink channel 804, which may be considered as the raw data. In some aspects, the size of the raw data may be related to the bandwidth, the sampling rate, or a quantization level. In some aspects, the content of the OOD dataset may comprise extracted latent data, which may represent a feature of the raw data input. The base station may configure the feature extraction model for the UE. For example, the machine learning model may be a separate model (e.g., compressed function PCA). In some aspects, the machine learning model may be part of the model in the UE. In some aspects, for example in channel feedback scenarios, the model 802 in the UE may output the compressed channel information 806 and feedback the compressed channel information 806 to the network. The base station may configure an SVD function as a feature extraction model 812, as shown for example in diagram 810 of FIG. 8B, wherein the estimated downlink channel 804 is the input to the feature extraction model 812. After the SVD processing, vectors of maximum singular values may be the extracted latent data 816. The size of the extracted latent data may be very small, for example, in comparison to the raw data. The latent data may still keep most of the features of the raw data. In some aspects, the content of the OOD dataset may indicate the type of the content of the reported OOD dataset, raw data, or extracted latent data. In instances where the UE reports the extracted latent data, the network may configure a corresponding extraction model. The model may comprise a common model, e.g., PCA method for all of the tasks. In some aspects, the model may comprise a specific model for a task, e.g., SVD for channel feedback or machine learning model for positioning.

As illustrated at 710, the UE 702 may detect an occurrence of one or more OOD events. An OOD event may be an event that occurs outside or beyond a previous logged dataset that is ID. The occurrence of the OOD event may be unavoidable, unknown, or unpredictable. The occurrence of the OOD event may cause the machine learning model to fail.

As illustrated at 712, the base station 704 may transmit a triggering message to the UE. For example, 1506 may be performed by trigger component 1642 of apparatus 1602. The OOD dataset may be transmitted by the UE in response to receipt of the triggering message from the base station. In some aspects, if the base station meets a performance loss for the model, the base station may configure resources for the UE to report the OOD dataset. The base station may transmit the triggering message in response to meeting the performance loss for the model. The triggering message may be configured via RRC signaling or MAC-CE.

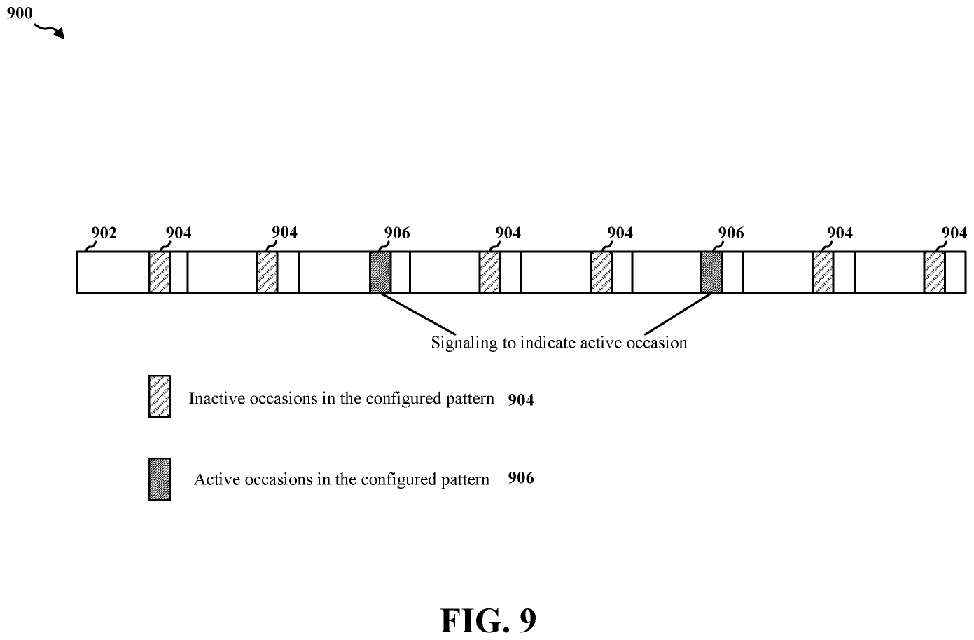

As illustrated at 714, the UE 702 may report the OOD dataset comprising the one or more OOD events. The UE may report the OOD dataset comprising the one or more OOD events based on the configuration to report the OOD dataset. The base station 704 may receive the OOD dataset from the UE 702. In some aspects, the OOD dataset may comprise the raw data related to the one or more OOD events. In some aspects, the OOD dataset may comprise the extracted latent data corresponding to features of raw data related to the one or more OOD events. The configuration to report the OOD dataset may include instructions for obtaining the extracted latent data. The reporting of the OOD dataset may be based on a schedule within the configuration to report the OOD dataset. The schedule may comprise a periodic pattern for the reporting of the OOD dataset. For example, with reference to diagram 900 of FIG. 9, the periodic pattern 902 may include one or more inactive occasions 904 and/or one or more active occasions 906. For example, in instances where the active occasion 906 is received by the UE, the UE may report the logged OOD events. In some instances, the base station may configure a pattern to transmit the OOD dataset, such that the base station may expect to receive the OOD dataset from the UE. The UE may report the OOD events if the UE buffer has logged any OOD events. The pattern may be configured via RRC signaling. The active occasion 906 may be configured via RRC signaling, MAC-CE, or DCI. In some aspects, the OOD dataset may be reported in response to the occurrence of each OOD event.

In some aspects, to report the OOD dataset, the UE 702, at 1002, may transmit a request to report the OOD dataset to the base station 704. The base station 704 may receive the request from the UE 702. The request to report the OOD dataset may include information related to the OOD dataset. For example, the information related to the OOD dataset may include at least one of the reported OOD dataset size or the types of the corresponding models. The UE may transmit the request to report the OOD dataset if the logged OOD events meet a buffer budget. The request to report the OOD dataset may be transmitted via RRC signaling.

In some aspects, the base station 704, at 1004, may transmit a grant to report the OOD dataset to the UE 702. The UE 702 may receive the grant to report the OOD dataset from the base station 704. The base station may transmit the grant to report the OOD dataset in response to transmitting the request to report the OOD dataset. In some aspects, the grant to report the OOD dataset may comprise a grant for OOD datasets related to one or more specific models. The grant may comprise the available resource the UE may utilize to report the OOD dataset. The grant may be transmitted via RRC signaling.

In some aspects, the UE 702 may transmit the OOD dataset to the base station 704. The base station 704 may receive the OOD dataset from the UE 702. The UE may transmit the OOD dataset based on the grant. The OOD dataset comprising the one or more OOD events.

As illustrated at 716, the base station 704 may update the machine learning model. The base station may update the machine learning model based on the OOD dataset. The base station may optimize the machine learning model based on the OOD dataset. The OOD dataset may comprise new logged dataset of OOD occurrences that the base station may utilize to optimize the machine learning model. In some aspects, the machine learning model may be updated based on a limited dataset. For example, part of the machine learning model may be fine-tuned while the remaining part of the machine learning model remains the same. In some aspects, the updated model may comprise a model structure difference, corresponding weights difference, corresponding quantization method for the update, or a reference model of the difference (e.g., at time t+1, the updated model may comprise the difference compared to the model at time t). In some aspects, data augmentation may be utilized to increase the new logged OOD dataset, such that the base station is utilizing active learning to update the machine learning model. In some aspects, a whole new model may be configured for the UE. In some aspects, the updated model may also indicate available time or conditions. For example, the updated model may be used in the serving cell, or the interference larger than a threshold. In some aspects, the updated model may be effective for a certain period of time.

As illustrated at 718, the base station 704 may transmit an update to the machine learning model. The base station may transmit the update to the machine learning model to the UE 702. The UE 702 may receive the update to the machine learning model from the base station 704. In some aspects, the update to the machine learning model may comprise the new machine learning model. In some aspects, the update to the machine learning mode may comprise the difference to the machine learning model.

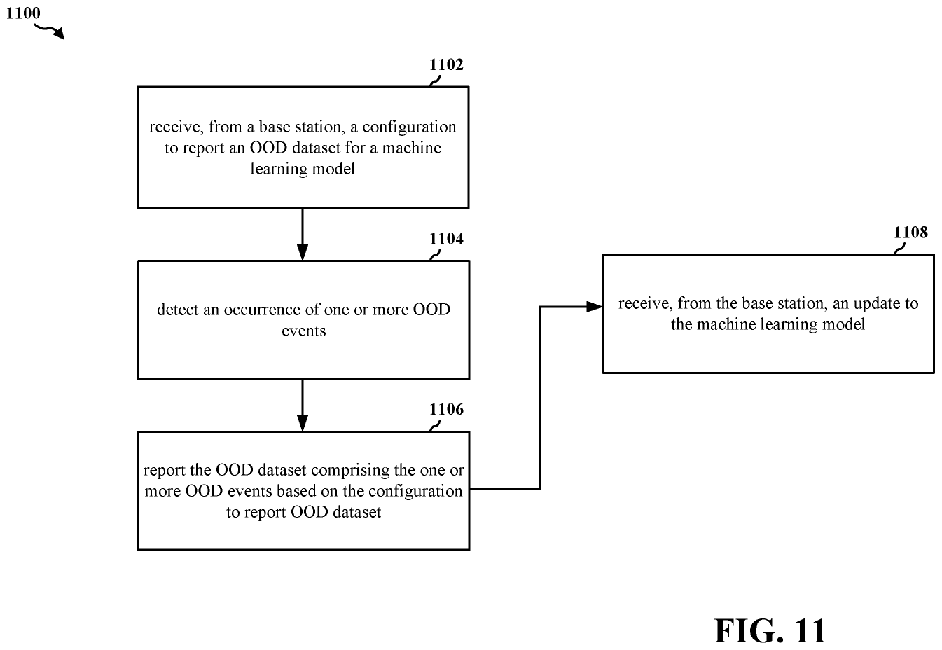

FIG. 11 is a flowchart 1100 of a method of wireless communication. The method may be performed by a UE or a component of a UE (e.g., the UE 104; the apparatus 1302; the cellular baseband processor 1304, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to report OOD occurrences for optimization of neural networks.

At 1102, the UE may receive a configuration to report an out of distribution (OOD) dataset. For example, 1102 may be performed by configuration component 1340 of apparatus 1302. The UE may receive the configuration to report the OOD dataset for a machine learning model. The UE may receive the configuration to report the OOD dataset from a base station. In some aspects, the configuration to report the OOD dataset may include a content configuration for a type of content to be included in the OOD dataset. The configuration may be received via DCI or MAC-CE. In the context of FIG. 7, the UE 702 may receive the configuration 708 to report the OOD dataset.

At 1104, the UE may detect an occurrence of one or more OOD events. For example, 1104 may be performed by OOD component 1342 of apparatus 1302. An OOD event may be an event that occurs outside or beyond a previous logged dataset that is in-distribution (ID). The occurrence of the OOD event may be unavoidable, unknown, or unpredictable. The occurrence of the OOD event may cause the machine learning model to fail. In the context of FIG. 7, the UE 702, at 710, may detect the occurrence of the one or more OOD events.

At 1106, the UE may report the OOD dataset comprising the one or more OOD events. For example, 1106 may be performed by OOD component 1342 of apparatus 1302. The UE may report the OOD dataset comprising the one or more OOD events based on the configuration to report the OOD dataset. The UE may report the OOD dataset to a base station. In some aspects, the OOD dataset may comprise raw data related to the one or more OOD events. In some aspects, the OOD dataset may comprise extracted latent data corresponding to features of raw data related to the one or more OOD events. The configuration to report the OOD dataset may include instructions for obtaining the extracted latent data. The reporting of the OOD dataset may be based on a schedule within the configuration to report the OOD dataset. The schedule may comprise a periodic pattern for the reporting of the OOD dataset. In some aspects, the OOD dataset may be reported in response to the occurrence of each OOD event. In the context of FIG. 7, the UE 702, at 714, may report the OOD dataset comprising the one or more OOD events.

At 1108, the UE may receive an update to the machine learning model. For example, 1108 may be performed by update component 1348 of apparatus 1302. The UE may receive the update to the machine learning model from the base station. In some aspects, the update to the machine learning model may comprise a new machine learning model. In some aspects, the update to the machine learning model may comprise a difference to the machine learning model. The UE may implement the update to the machine learning model received from the base station. In the context of FIG. 7, the UE 702, at 718, may receive the update to the machine learning model.

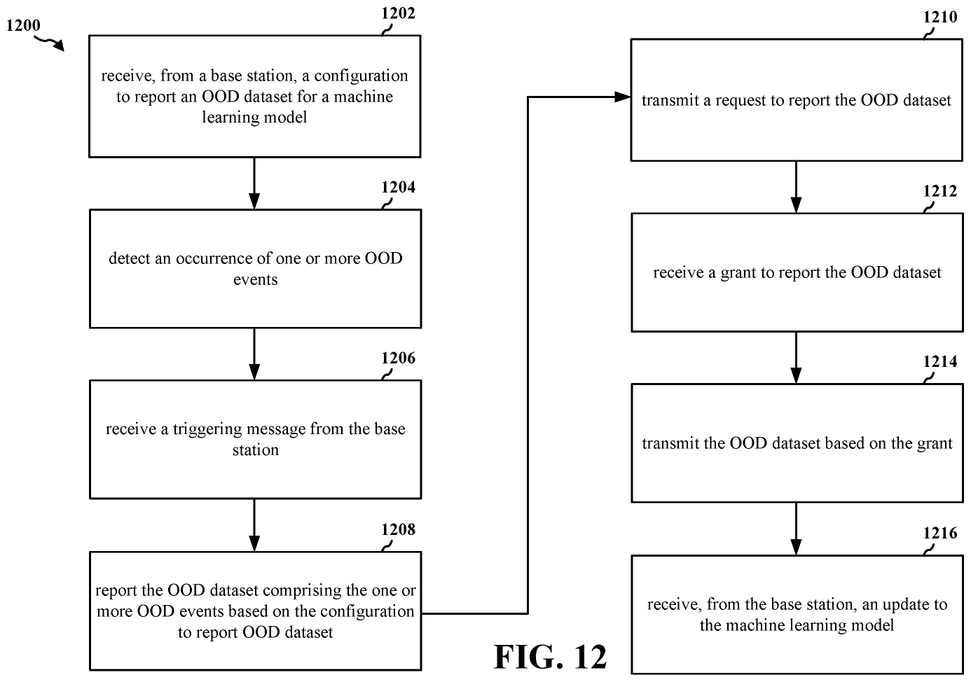

FIG. 12 is a flowchart 1200 of a method of wireless communication. The method may be performed by a UE or a component of a UE (e.g., the UE 104; the apparatus 1302; the cellular baseband processor 1304, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to report OOD occurrences for optimization of neural networks.

At 1202, the UE may receive a configuration to report an out of distribution (OOD) dataset. For example, 1202 may be performed by configuration component 1340 of apparatus 1302. The UE may receive the configuration to report the OOD dataset for a machine learning model. The UE may receive the configuration to report the OOD dataset from a base station. In some aspects, the configuration to report the OOD dataset may include a content configuration for a type of content to be included in the OOD dataset. The configuration may be received via DCI or MAC-CE. In the context of FIG. 7, the UE 702 may receive the configuration 708 to report the OOD dataset.

At 1204, the UE may detect an occurrence of one or more OOD events. For example, 1204 may be performed by OOD component 1342 of apparatus 1302. An OOD event may be an event that occurs outside or beyond a previous logged dataset that is ID. The occurrence of the OOD event may be unavoidable, unknown, or unpredictable. The occurrence of the OOD event may cause the machine learning model to fail. In the context of FIG. 7, the UE 702, at 710, may detect the occurrence of the one or more OOD events.

At 1206, the UE may receive a triggering message from the base station. For example, 1206 may be performed by trigger component 1344 of apparatus 1302. The reporting of the OOD dataset may be triggered in response to receipt of the triggering message. In some aspects, if the base station meets a performance loss for the model, the base station may configure resources for the UE to report the OOD dataset. The UE may report the OOD dataset having logged OOD events. The triggering message may be configured via RRC signaling or MAC-CE. In the context of FIG. 7, the UE 702, at 712, may receive the triggering message from the base station 704.

At 1208, the UE may report the OOD dataset comprising the one or more OOD events. For example, 1206 may be performed by OOD component 1342 of apparatus 1302. The UE may report the OOD dataset comprising the one or more OOD events based on the configuration to report the OOD dataset. In some aspects, the OOD dataset may comprise raw data related to the one or more OOD events. In some aspects, the OOD dataset may comprise extracted latent data corresponding to features of raw data related to the one or more OOD events. The configuration to report the OOD dataset may include instructions for obtaining the extracted latent data. The reporting of the OOD dataset may be based on a schedule within the configuration to report the OOD dataset. The schedule may comprise a periodic pattern for the reporting of the OOD dataset. In some aspects, the OOD dataset may be reported in response to the occurrence of each OOD event. In the context of FIG. 7, the UE 702, at 714, may report the OOD dataset comprising the one or more OOD events.

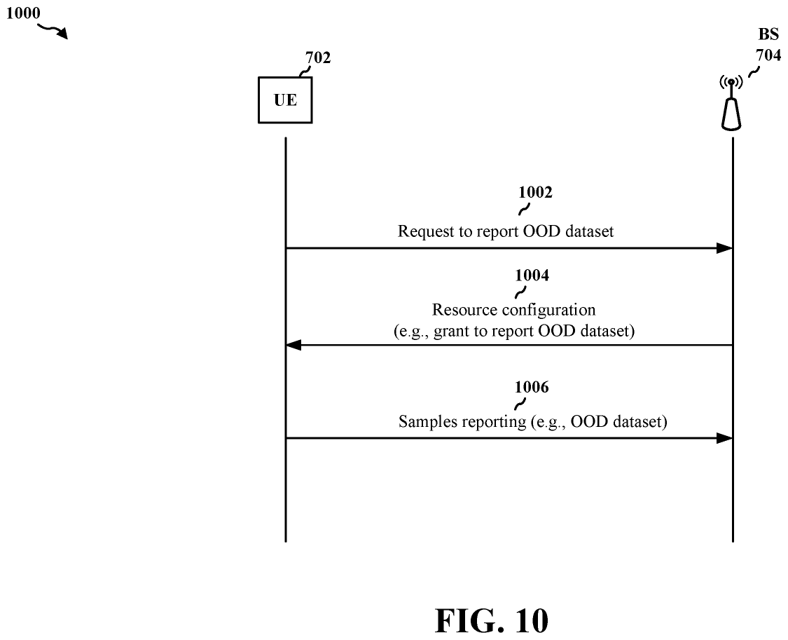

At 1210, the UE may transmit a request to report the OOD dataset. For example, 1210 may be performed by OOD component 1342 of apparatus 1302. The request to report the OOD dataset may include information related to the OOD dataset. For example, the information related to the OOD dataset may include at least one of the reported OOD dataset size or the types of the corresponding models. The UE may transmit the request to report the OOD dataset if the logged OOD events meet a buffer budget. The request to report the OOD dataset may be transmitted via RRC signaling. In the context of FIG. 10, the UE 702, at 1002, may transmit the request to report the OOD dataset.

At 1212, the UE may receive a grant to report the OOD dataset. For example, 1212 may be performed by OOD component 1342 of apparatus 1302. The UE may receive the grant to report the OOD dataset from the base station. The UE may receive the grant to report the OOD dataset in response to transmitting the request to report the OOD dataset. In some aspects, the grant to report the OOD dataset may comprise a grant for OOD datasets related to one or more specific models. The grant may comprise the available resource the UE may utilize to report the OOD dataset. The grant may be received via RRC signaling. In the context of FIG. 10, the UE 702, at 1004, may receive the grant to report the OOD dataset.

At 1214, the UE may transmit the OOD dataset. For example, 1214 may be performed by OOD component 1342 of apparatus 1302. The UE may transmit the OOD dataset based on the grant. The UE may transmit the OOD dataset to the base station. In the context of FIG. 10, the UE 702 may transmit the OOD dataset to the base station 704.

At 1216, the UE may receive an update to the machine learning model. For example, 1216 may be performed by update component 1348 of apparatus 1302. The UE may receive the update to the machine learning model from the base station. In some aspects, the update to the machine learning model may comprise a new machine learning model. In some aspects, the update to the machine learning model may comprise a difference to the machine learning model. The UE may implement the update to the machine learning model received from the base station. In the context of FIG. 7, the UE 702, at 718, may receive the update to the machine learning model.

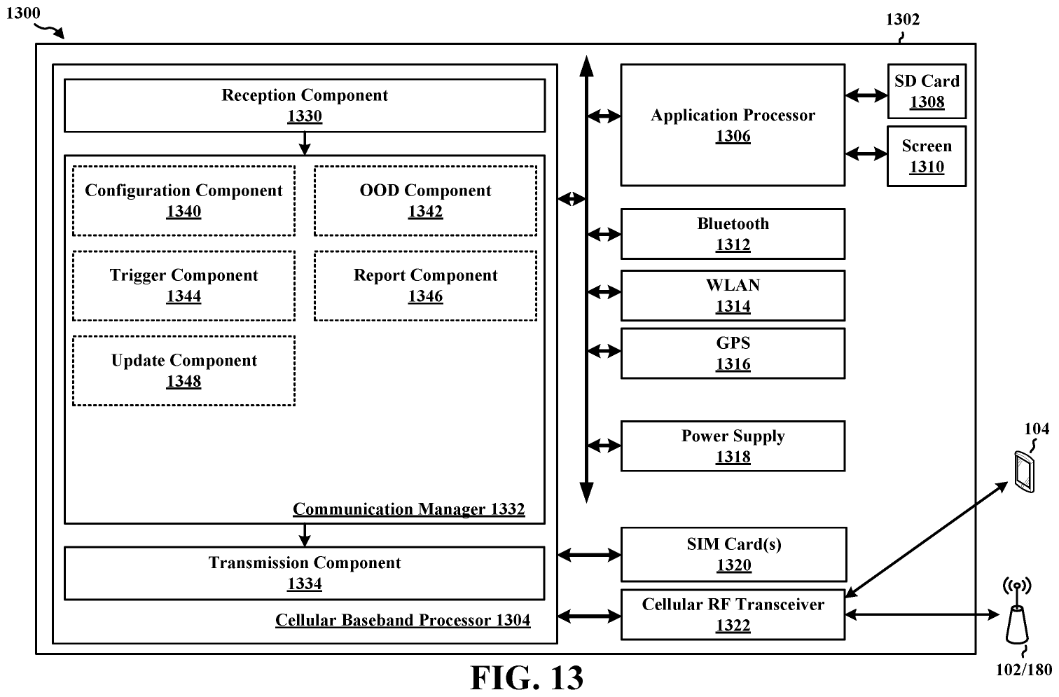

FIG. 13 is a diagram 1300 illustrating an example of a hardware implementation for an apparatus 1302. The apparatus 1302 is a UE and includes a cellular baseband processor 1304 (also referred to as a modem) coupled to a cellular RF transceiver 1322 and one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, and a power supply 1318. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the aforediscussed additional modules of the apparatus 1302.

The communication manager 1332 includes a configuration component 1340 that is configured to receive a configuration to report an OOD dataset, e.g., as described in connection with 1102 of FIG. 11 or 1202 of FIG. 12. The communication manager 1332 further includes an OOD component 1342 that is configured to detect an occurrence of one or more OOD events e.g., as described in connection with 1104 of FIG. 11 or 1204 of FIG. 12. The OOD component 1342 may be configured to transmit a request to report the OOD dataset, e.g., as described in connection with 1210 of FIG. 12. The OOD component 1342 may be configured to receive a grant to report the OOD dataset, e.g., as described in connection with 1212 of FIG. 12. The OOD component 1342 may be configured to transmit the OOD dataset, e.g., as described in connection with 1214 of FIG. 12. The communication manager 1332 further includes a trigger component 1344 that is configured to receive a triggering message from the base station, e.g., as described in connection with 1206 of FIG. 12. The communication manager 1332 further includes a report component 1346 that is configured to report the OOD dataset comprising the one or more OOD events, e.g., as described in connection with 1106 of FIG. 11 or 1208 of FIG. 12. The communication manager 1332 further includes an update component 1348 that is configured to receive an update to the machine learning model, e.g., as described in connection with 1108 of FIG. 11 or 1216 of FIG. 12.

The apparatus may include additional components that perform each of the blocks of the algorithm in the aforementioned flowcharts of FIG. 11 or 12. As such, each block in the aforementioned flowcharts of FIG. 11 or 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the cellular baseband processor 1304, includes means for receiving, from a base station, a configuration to report an OOD dataset for a machine learning model. The apparatus includes means for detecting an occurrence of one or more OOD events. The apparatus includes means for reporting the OOD dataset comprising the one or more OOD events based on the configuration to report OOD dataset. The apparatus includes means for receiving, from the base station, an update to the machine learning model. The apparatus further includes means for receiving a triggering message from the base station. The reporting of the OOD dataset is triggered in response to receipt of the triggering message. The apparatus further includes means for transmitting a request to report the OOD dataset. The apparatus further includes means for receiving a grant to report the OOD dataset. The apparatus further includes means for transmitting the OOD dataset based on the grant. The aforementioned means may be one or more of the aforementioned components of the apparatus 1302 configured to perform the functions recited by the aforementioned means. As described supra, the apparatus 1302 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

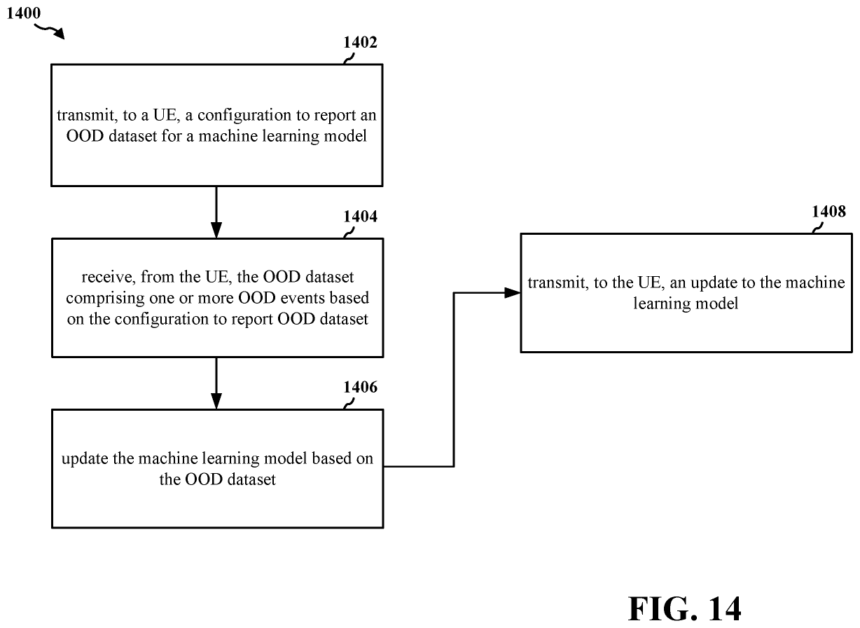

FIG. 14 is a flowchart 1400 of a method of wireless communication. The method may be performed by a base station or a component of a base station (e.g., the base station 102/180; the apparatus 1602; the baseband unit 1604, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE to report OOD occurrences for optimization of neural networks.

At 1402, the base station may transmit a configuration to report an OOD dataset. For example, 1402 may be performed by configuration component 1640 of apparatus 1602. The base station may transmit the configuration to report the OOD dataset for a machine learning model. The base station may transmit the configuration to report the OOD dataset to a UE. In some aspects, the configuration to report the OOD dataset may include a content configuration for a type of content to be included in the OOD dataset. In the context of FIG. 7, the base station 704, at 708, may transmit the configuration to report the OOD dataset.

At 1404, the base station may receive the OOD dataset comprising one or more OOD events. For example, 1404 may be performed by OOD component 1644 of apparatus 1602. The base station may receive the OOD dataset comprising the one or more OOD events based on the configuration to report the OOD dataset. The base station may receive the OOD dataset from the UE. In some aspects, the OOD dataset may comprise raw data related to the one or more OOD events. In some aspects, the OOD dataset may comprise extracted latent data corresponding to features of raw data related to the one or more OOD events. The configuration to report the OOD dataset may include instructions for obtaining the extracted latent data. The OOD dataset may be received based on a schedule within the configuration to report the OOD dataset. The OOD dataset may be received based on a periodic pattern of the schedule within the configuration to report the OOD dataset. In some aspects, the OOD dataset may be received in response to the occurrence of each OOD event. In the context of FIG. 7, the base station 704, at 714, may receive the OOD dataset comprising the one or more OOD events.

At 1406, the base station may update the machine learning model. For example, 1406 may be performed by update component 1646 of apparatus 1602. The base station may update the machine learning model based on the OOD dataset. The base station may optimize the machine learning model based on the OOD dataset. The OOD dataset may comprise new logged dataset of OOD occurrences that the base station may utilize to optimize the machine learning model. In some aspects, the machine learning model may be updated based on a limited dataset. For example, part of the machine learning model may be fine-tuned while the remaining part of the machine learning model remains the same. In some aspects, data augmentation may be utilized to increase the new logged OOD dataset, such that the base station is utilizing active learning to update the machine learning model. In the context of FIG. 7, the base station 704, at 716, may update the machine learning model.

At 1408, the base station may transmit an update to the machine learning model. For example, 1408 may be performed by update component 1646 of apparatus 1602. The base station may transmit the update to the machine learning model to the UE. In some aspects, the update to the machine learning model may comprise a new machine learning model. In some aspects, the update to the machine learning mode may comprise a difference to the machine learning model. In the context of FIG. 7, the base station 704, at 718, may transmit the update to the machine learning model.

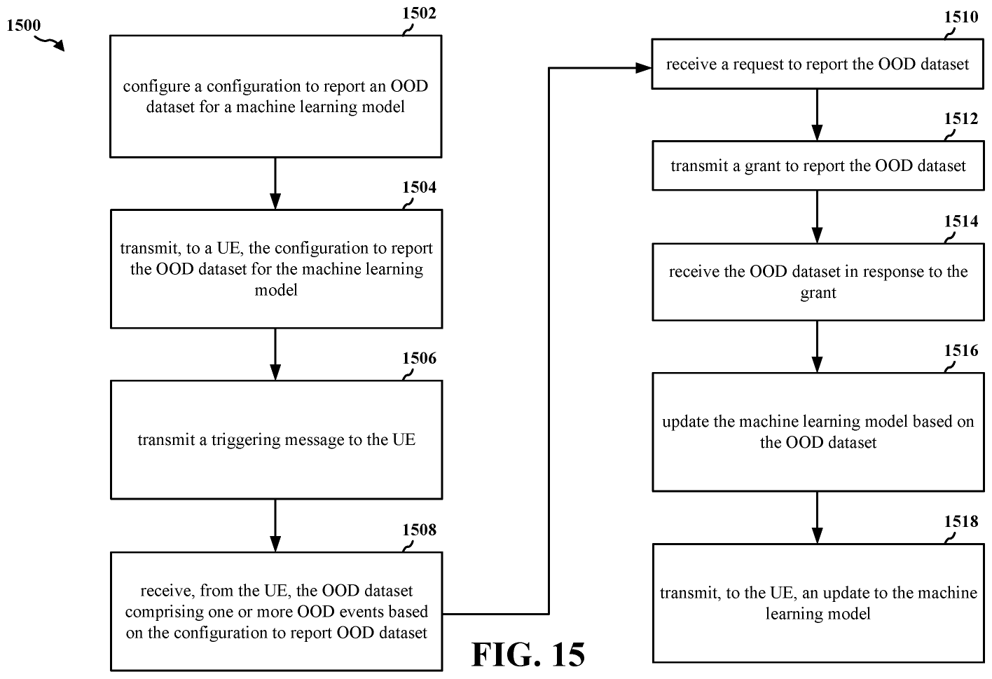

FIG. 15 is a flowchart 1500 of a method of wireless communication. The method may be performed by a base station or a component of a base station (e.g., the base station 102/180; the apparatus 1602; the baseband unit 1604, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE to report OOD occurrences for optimization of neural networks.

At 1502, the base station may configure a configuration to report an OOD dataset. For example, 1502 may be performed by configuration component 1640 of apparatus 1602. The base station may configure the configuration to report the OOD dataset for a machine learning model. In the context of FIG. 7, the base station 704, at 706, may configure the configuration to report the OOD dataset.

At 1504, the base station may transmit the configuration to report the OOD dataset. For example, 1504 may be performed by configuration component 1640 of apparatus 1602. The base station may transmit the configuration to report the OOD dataset for a machine learning model. The base station may transmit the configuration to report the OOD dataset to a UE. In some aspects, the configuration to report the OOD dataset may include a content configuration for a type of content to be included in the OOD dataset. In the context of FIG. 7, the base station 704, at 708, may transmit the configuration to report the OOD dataset.

At 1506, the base station may transmit a triggering message to the UE. For example, 1506 may be performed by trigger component 1642 of apparatus 1602. The OOD dataset may be transmitted by the UE in response to receipt of the triggering message from the base station. In some aspects, if the base station meets a performance loss for the model, the base station may configure resources for the UE to report the OOD dataset. The base station may transmit the triggering message in response to meeting the performance loss for the model. The triggering message may be configured via RRC signaling or MAC-CE. In the context of FIG. 7, the base station 704, at 712, may transmit the triggering message to the UE 702.

At 1508, the base station may receive the OOD dataset comprising one or more OOD events. For example, 1508 may be performed by OOD component 1644 of apparatus 1602. The base station may receive the OOD dataset comprising the one or more OOD events based on the configuration to report the OOD dataset. The base station may receive the OOD dataset from the UE. In some aspects, the OOD dataset may comprise raw data related to the one or more OOD events. In some aspects, the OOD dataset may comprise extracted latent data corresponding to features of raw data related to the one or more OOD events. The configuration to report the OOD dataset may include instructions for obtaining the extracted latent data. The OOD dataset may be received based on a schedule within the configuration to report the OOD dataset. The OOD dataset may be received based on a periodic pattern of the schedule within the configuration to report the OOD dataset. In some aspects, the OOD dataset may be received in response to the occurrence of each OOD event. In the context of FIG. 7, the base station 704, at 714, may receive the OOD dataset comprising the one or more OOD events.

At 1510, the base station may receive a request to report the OOD dataset. For example, 1510 may be performed by OOD component 1644 of apparatus 1602. The request to report the OOD dataset may include information related to the OOD dataset. For example, the information related to the OOD dataset may include at least one of the reported OOD dataset size or the types of the corresponding models. The base station may receive the request to report the OOD dataset if the logged OOD events meet a buffer budget. The request to report the OOD dataset may be transmitted via RRC signaling. In the context of FIG. 10, the base station 704, at 1002, may receive the request to report the OOD dataset.

At 1512, the base station may transmit a grant to report the OOD dataset. For example, 1512 may be performed by OOD component 1644 of apparatus 1602. The base station may transmit the grant to report the OOD dataset to the UE. The base station may transmit the grant to report the OOD dataset in response to transmitting the request to report the OOD dataset. In some aspects, the grant to report the OOD dataset may comprise a grant for OOD datasets related to one or more specific models. The grant may comprise the available resource the UE may utilize to report the OOD dataset. The grant may be transmitted via RRC signaling. In the context of FIG. 10, the base station 704, at 1004, may transmit the grant to report the OOD dataset.

At 1514, the base station may receive the OOD dataset. For example, 1514 may be performed by OOD component 1644 of apparatus 1602. The base station may receive the OOD dataset based on the grant. The base station may receive the OOD dataset from the UE. In the context of FIG. 10, the base station 704, at 1006, may receive the OOD dataset.

At 1516, the base station may update the machine learning model. For example, 1516 may be performed by update component 1646 of apparatus 1602. The base station may update the machine learning model based on the OOD dataset. The base station may optimize the machine learning model based on the OOD dataset. The OOD dataset may comprise new logged dataset of OOD occurrences that the base station may utilize to optimize the machine learning model. In some aspects, the machine learning model may be updated based on a limited dataset. For example, part of the machine learning model may be fine-tuned while the remaining part of the machine learning model remains the same. In some aspects, data augmentation may be utilized to increase the new logged OOD dataset, such that the base station is utilizing active learning to update the machine learning model. In the context of FIG. 7, the base station 704, at 716, may update the machine learning model.

At 1518, the base station may transmit an update to the machine learning model. For example, 1518 may be performed by update component 1646 of apparatus 1602. The base station may transmit the update to the machine learning model to the UE. In some aspects, the update to the machine learning model may comprise a new machine learning model. In some aspects, the update to the machine learning mode may comprise a difference to the machine learning model. In the context of FIG. 7, the base station 704, at 718, may transmit the update to the machine learning model.

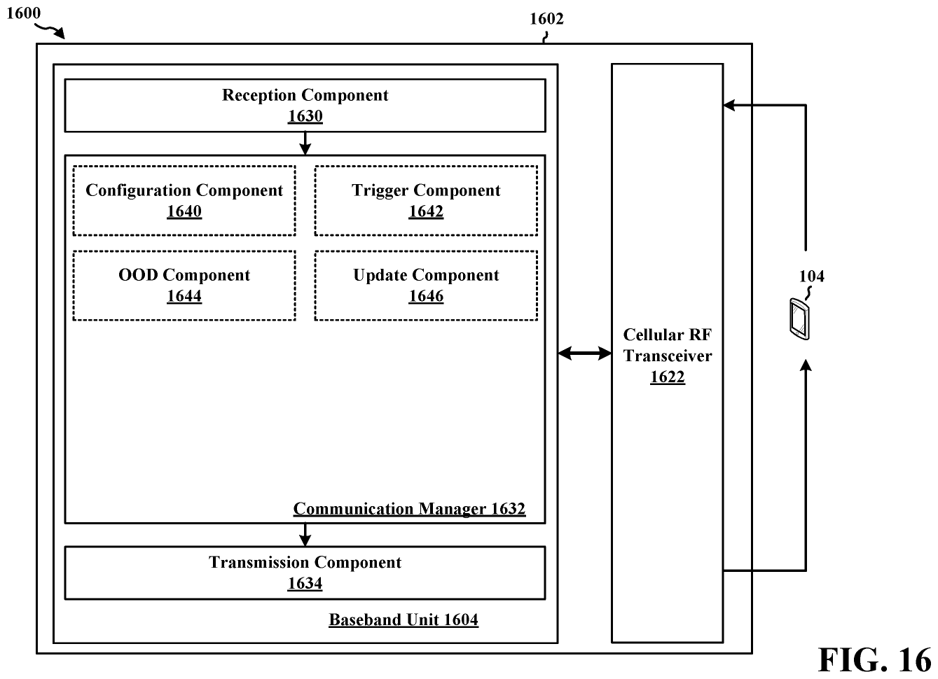

FIG. 16 is a diagram 1600 illustrating an example of a hardware implementation for an apparatus 1602. The apparatus 1602 is a BS and includes a baseband unit 1604. The baseband unit 1604 may communicate through a cellular RF transceiver 1622 with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the BS 310 and may include the memory 376 and/or at least one of the TX processor 316, the RX processor 370, and the controller/processor 375.

The communication manager 1632 includes a configuration component 1640 that may configure a configuration to report an OOD dataset, e.g., as described in connection with 1502 of FIG. 15. The configuration component 1640 may be configured to transmit the configuration to report the OOD dataset, e.g., as described in connection with 1402 of FIG. 14 or 1504 of FIG. 15. The communication manager 1632 further includes a trigger component 1642 that may transmit a triggering message to the UE, e.g., as described in connection with 1506 of FIG. 15. The communication manager 1632 further includes an OOD component 1644 that may receive the OOD dataset comprising one or more OOD events, e.g., as described in connection with 1404 of FIG. 14 or 1508 of FIG. 15. The OOD component 1644 may be configured to receive a request to report the OOD dataset, e.g., as described in connection with 1510 of FIG. 15. The OOD component 1644 may be configured to transmit a grant to report the OOD dataset, e.g., as described in connection with 1512 of FIG. 15. The OOD component 1644 may be configured to receive the OOD dataset, e.g., as described in connection with 1514 of FIG. 15. The communication manager 1632 further includes an update component 1646 that may update the machine learning model, e.g., as described in connection with 1406 of FIG. 14 or 1516 of FIG. 15. The update component may be configured to transmit an update to the machine learning model, e.g., as described in connection with 1408 of FIG. 14 or 1518 of FIG. 15.

The apparatus may include additional components that perform each of the blocks of the algorithm in the aforementioned flowcharts of FIG. 14 or 15. As such, each block in the aforementioned flowcharts of FIG. 14 or 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the baseband unit 1604, includes means for transmitting, to a UE, a configuration to report an OOD dataset for a machine learning model. The apparatus includes means for receiving, from the UE, the OOD dataset comprising one or more OOD events based on the configuration to report OOD dataset. The apparatus includes means for updating the machine learning model based on the OOD dataset. The apparatus includes means for transmitting, to the UE, an update to the machine learning model. The apparatus further includes means for configuring the configuration to report the OOD dataset for the machine learning model. The apparatus further includes means for transmitting a triggering message to the UE. The OOD dataset is transmitted by the UE in response to receipt of the triggering message from the base station. The apparatus further includes means for receiving a request to report the OOD dataset. The apparatus further includes means for transmitting a grant to report the OOD dataset. The apparatus further includes means for receiving the OOD dataset in response to the grant. The aforementioned means may be one or more of the aforementioned components of the apparatus 1602 configured to perform the functions recited by the aforementioned means. As described supra, the apparatus 1602 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.
Aspect 1 is a method of wireless communication at a UE comprising receiving, from a base station, a configuration to report an OOD dataset for a machine learning model; detecting an occurrence of one or more OOD events; reporting the OOD dataset comprising the one or more OOD events based on the configuration to report OOD dataset; and receiving, from the base station, an update to the machine learning model.
In Aspect 2, the method of Aspect 1 further includes that the OOD dataset comprises raw data related to the one or more OOD events.
In Aspect 3, the method of Aspect 1 or 2 further includes that the OOD dataset comprises extracted latent data corresponding to features of raw data related to the one or more OOD events.
In Aspect 4, the method of any of Aspects 1-3 further includes that the configuration to report the OOD dataset includes instructions for obtaining the extracted latent data.
In Aspect 5, the method of any of Aspects 1-4 further includes that the configuration to report the OOD dataset includes a content configuration for a type of content included in the OOD dataset.
In Aspect 6, the method of any of Aspects 1-5 further includes that the reporting the OOD dataset is based on a schedule within the configuration to report the OOD dataset.
In Aspect 7, the method of any of Aspects 1-6 further includes that the schedule comprises a periodic pattern for the reporting the OOD dataset.
In Aspect 8, the method of any of Aspects 1-7 further includes receiving a triggering message from the base station, wherein the reporting of the OOD dataset is triggered in response to receipt of the triggering message.
In Aspect 9, the method of any of Aspects 1-8 further includes that the OOD dataset is reported in response to the occurrence of each OOD event.
In Aspect 10, the method of any of Aspects 1-9 further includes that the reporting the OOD dataset further includes transmitting a request to report the OOD dataset; receiving a grant to report the OOD dataset; and transmitting the OOD dataset based on the grant.
In Aspect 11, the method of any of Aspects 1-10 further includes that the update to the machine learning model comprises a new machine learning model or a difference to the machine learning model.
Aspect 12 is a device including a transceiver, one or more processors, and one or more memories in electronic communication with the transceiver and the one or more processors and storing instructions executable by the one or more processors to cause the device to implement a method as in any of Aspects 1-11.
Aspect 13 is a system or apparatus including means for implementing a method or realizing an apparatus as in any of Aspects 1-11.
Aspect 14 is a non-transitory computer readable storage medium storing instructions executable by one or more processors to cause the one or more processors to implement a method as in any of Aspect 1-11.
Aspect 15 is a method of wireless communication at a base station comprising transmitting, to a UE, a configuration to report an OOD dataset for a machine learning model; receiving, from the UE, the OOD dataset comprising one or more OOD events based on the configuration to report OOD dataset; updating the machine learning model based on the OOD dataset; and transmitting, to the UE, an update to the machine learning model.
In Aspect 16, the method of Aspect 15 further includes configuring the configuration to report the OOD dataset for the machine learning model.
In Aspect 17, the method of Aspect 15 or 16 further includes that the OOD dataset comprises raw data related to the one or more OOD events.
In Aspect 18, the method of any of Aspects 15-17 further includes that the OOD dataset comprises extracted latent data corresponding to features of raw data related to the one or more OOD events.
In Aspect 19, the method of any of Aspects 15-18 further includes that the configuration to report the OOD dataset includes instructions for obtaining the extracted latent data.
In Aspect 20, the method of any of Aspects 15-19 further includes that the configuration to report the OOD dataset includes a content configuration for a type of content included in the OOD dataset.
In Aspect 21, the method of any of Aspects 15-20 further includes that the OOD dataset is received based on a schedule within the configuration to report the OOD dataset.
In Aspect 22, the method of any of Aspects 15-21 further includes that the OOD dataset is received based on a periodic pattern of the schedule within the configuration to report the OOD dataset.
In Aspect 23, the method of any of Aspects 15-22 further includes transmitting a triggering message to the UE, wherein the OOD dataset is transmitted by the UE in response to receipt of the triggering message from the base station.
In Aspect 24, the method of any of Aspects 15-23 further includes that the OOD dataset is received in response to an occurrence of each OOD event.
In Aspect 25, the method of any of Aspects 15-24 further includes that the receiving the OOD dataset further includes receiving a request to report the OOD dataset; transmitting a grant to report the OOD dataset; and receiving the OOD dataset in response to the grant.
In Aspect 26, the method of any of Aspects 15-25 further includes that the update to the machine learning model comprises a new machine learning model or a difference to the machine learning model.
Aspect 27 is a device including a transceiver, one or more processors, and one or more memories in electronic communication with the transceiver and the one or more processors and storing instructions executable by the one or more processors to cause the device to implement a method as in any of Aspects 15-26.
Aspect 28 is a system or apparatus including means for implementing a method or realizing an apparatus as in any of Aspects 15-26.
Aspect 29 is a non-transitory computer readable storage medium storing instructions executable by one or more processors to cause the one or more processors to implement a method as in any of Aspect 15-26.

What is claimed is:

1. An apparatus for wireless communication at a user equipment (UE), comprising:
a memory;
a transceiver; and
a processor, communicatively connected to the memory and the transceiver, the processor configured to:
receive, from a base station, a configuration to report an out of distribution (OOD) dataset for a machine learning model;
detect an occurrence of one or more OOD events;
report the OOD dataset comprising the one or more OOD events based on the configuration to report OOD dataset; and
receive, from the base station, an update to the machine learning model.

2. The apparatus of claim 1, wherein the OOD dataset comprises raw data related to the one or more OOD events.

3. The apparatus of claim 1, wherein the OOD dataset comprises extracted latent data corresponding to features of raw data related to the one or more OOD events.

4. The apparatus of claim 3, wherein the configuration to report the OOD dataset includes instructions for obtaining the extracted latent data.

5. The apparatus of claim 1, wherein the configuration to report the OOD dataset includes a content configuration for a type of content included in the OOD dataset.

6. The apparatus of claim 1, wherein reporting the OOD dataset is based on a schedule within the configuration to report the OOD dataset.

7. The apparatus of claim 6, wherein the schedule comprises a periodic pattern for the reporting the OOD dataset.

8. The apparatus of claim 1, the processor is further configured to:
receive a triggering message from the base station, wherein the reporting of the OOD dataset is triggered in response to receipt of the triggering message.

9. The apparatus of claim 1, wherein the OOD dataset is reported in response to the occurrence of each OOD event.

10. The apparatus of claim 1, wherein to report the OOD dataset, the processor is further configured to:
transmit a request to report the OOD dataset;
receive a grant to report the OOD dataset; and
transmit the OOD dataset based on the grant.

11. The apparatus of claim 1, wherein the update to the machine learning model comprises a new machine learning model or a difference to the machine learning model.

12. A method of wireless communication at a user equipment (UE), comprising:
receiving, from a base station, a configuration to report an out of distribution (OOD) dataset for a machine learning model;
detecting an occurrence of one or more OOD events;
reporting the OOD dataset comprising the one or more OOD events based on the configuration to report OOD dataset; and
receiving, from the base station, an update to the machine learning model.

13. The method of claim 12, wherein the OOD dataset comprises raw data related to the one or more OOD events or extracted latent data corresponding to features of raw data related to the one or more OOD events.

14. The method of claim 12, further comprising:
receiving a triggering message from the base station, wherein the reporting of the OOD dataset is triggered in response to receipt of the triggering message.

15. The method of claim 12, wherein the reporting the OOD dataset further comprises:
transmitting a request to report the OOD dataset;
receiving a grant to report the OOD dataset; and
transmitting the OOD dataset based on the grant.

16. An apparatus for wireless communication at a base station, comprising:
a memory;
a transceiver; and
a processor, communicatively connected to the memory and the transceiver, the processor configured to:
transmit, to a user equipment (UE), a configuration to report an out of distribution (OOD) dataset for a machine learning model;
receive, from the UE, the OOD dataset comprising one or more OOD events based on the configuration to report OOD dataset;
update the machine learning model based on the OOD dataset; and
transmit, to the UE, an update to the machine learning model.

17. The apparatus of claim 16, wherein the processor is further configured to:
configure the configuration to report the OOD dataset for the machine learning model.

18. The apparatus of claim 16, wherein the OOD dataset comprises raw data related to the one or more OOD events.

19. The apparatus of claim 16, wherein the OOD dataset comprises extracted latent data corresponding to features of raw data related to the one or more OOD events.

20. The apparatus of claim 19, wherein the configuration to report the OOD dataset includes instructions for obtaining the extracted latent data.

21. The apparatus of claim 16, wherein the configuration to report the OOD dataset includes a content configuration for a type of content included in the OOD dataset.

22. The apparatus of claim 16, wherein the OOD dataset is received based on a schedule within the configuration to report the OOD dataset.

23. The apparatus of claim 22, wherein the OOD dataset is received based on a periodic pattern of the schedule within the configuration to report the OOD dataset.

24. The apparatus of claim 16, wherein the processor is further configured to:
transmit a triggering message to the UE, wherein the OOD dataset is transmitted by the UE in response to receipt of the triggering message from the base station.

25. The apparatus of claim 16, wherein the OOD dataset is received in response to an occurrence of each OOD event.

26. The apparatus of claim 16, wherein to receive the OOD dataset, the processor is further configured to:
receive a request to report the OOD dataset;
transmit a grant to report the OOD dataset; and
receive the OOD dataset in response to the grant.

27. The apparatus of claim 16, wherein the update to the machine learning model comprises a new machine learning model or a difference to the machine learning model.

28. A method of wireless communication at a base station, comprising:
transmitting, to a user equipment (UE), a configuration to report an out of distribution (OOD) dataset for a machine learning model;
receiving, from the UE, the OOD dataset comprising one or more OOD events based on the configuration to report OOD dataset;
updating the machine learning model based on the OOD dataset; and
transmitting, to the UE, an update to the machine learning model.

29. The method of claim 28, further comprising:
transmitting a triggering message to the UE, wherein the OOD dataset is transmitted by the UE in response to receipt of the triggering message from the base station.

30. The method of claim 28, wherein the receiving the OOD dataset further comprises:
receiving a request to report the OOD dataset;
transmitting a grant to report the OOD dataset; and
receiving the OOD dataset in response to the grant.
